(19) United States
(12) Patent Application Publication
(10) Pub. No.: US 2026/0196568 A1
(43) Pub. Date: Jul. 9, 2026

(54) METHOD OF MANUFACTURING AN ELECTRODE-ELECTROLYTE LAMINATE

(71) Applicant: Dyson Technology Limited, Malmesbury, Wiltshire (GB)

(72) Inventors: John William Alexander POULTER, Bristol (GB); Matthew Robert ROBERTS, Oxford (GB)

(21) Appl. No.: 19/133,834

(22) PCT Filed: Nov. 21, 2023
(86) PCT No.: PCT/IB2023/061731

§ 371 Date: May 29, 2025

(30) Foreign Application Priority Data
Nov. 30, 2022 (GB) 2217987.3

(51) Int. Cl. H01M 10/058; H01M 4/02; H01M 10/0525; H01M 10/0562; H01M 50/426; H01M 50/434; H01M 50/451

(52) U.S. Cl. CPC H01M 10/058; H01M 10/0525; H01M 10/0562; H01M 50/426; H01M 50/434; H01M 50/451; H01M 2004/023; H01M 2300/0068

(57) ABSTRACT

Disclosed is an electrode-electrolyte laminate and a method of manufacturing an electrode-electrolyte laminate, for use in a lithium-metal cell. The method includes depositing a ceramic electrolyte layer onto a first surface of a polymer separator, and depositing a layer of lithium metal onto an exposed surface of the ceramic electrolyte layer. The electrode-electrolyte laminate prepared by the method is useful in the manufacture of an electrochemical cell.

### FIELD OF THE INVENTION

The present invention relates to a method of manufacturing an electrode-electrolyte laminate for use in a lithium-metal cell, and electrode-electrolyte laminates manufactured by such methods.

### BACKGROUND OF THE INVENTION

Lithium-ion secondary batteries are the leading battery technology currently used in applications from small personal devices to electric vehicles. Lithium-ion batteries are favoured for their high energy density and long cycle life, among other benefits. They contain a plurality of lithium-ion secondary cells, which is one example of an alkali metal ion secondary cell.

Lithium metal anodes are attracting interest due to their high energy density compared with more conventional anodes such as graphite. However Li anodes are prone to failure, primarily under two modes: firstly, Li dendrites may grow across the cell during operation, potentially leading to short-circuit and catastrophic cell failure. Secondly, the continued consumption of electrolyte components in SEI formation can impact cycle life and cell performance.

It is known to use a protective coating on the anode surface in order to address one or more of these drawbacks. For example, U.S. Pat. No. 7,939,205 describes a layer of “hard electrolyte” covering the negative and/or positive electrode. A layer of lithium phosphorus oxynitride (LiPON) is suggested as a coating on the anode to prevent the growth of dendrites across the cell.

However the inventors have found that the coating of LiPON onto the lithium metal anode by PVD leads to the conversion of some of the lithium in the anode to Li₃N, thereby reducing the energy density of the anode. Furthermore, aggressive species within the plasma used for deposition can produce Li₂O film on the surface of the Li metal anode, further reducing anode performance.

Traditional lithium-ion battery components such as electrodes are made from a solvent cast process that uses sacrificial solvent. This is an energetically expensive step, and a process that avoids using sacrificial solvent is therefore desirable.

A further major drawback of lithium-ion technology and other alkali-metal ion secondary cell technology is that a liquid electrolyte is often used within the lithium-ion cells of the battery, to provide conductivity of lithium ions within the cell between the solid, solvent cast anode and cathode. This causes safety problems since the liquid electrolytes are often highly flammable. This is a particular problem for electric vehicles, where a collision with another vehicle may be relatively likely and the resulting impact may cause damage to the battery and ignition of the electrolyte. It is also a problem for devices used in the home, where a lithium-ion battery fire could cause damage to property or serious injury.

One approach to avoiding the use of sacrificial solvent, and the need for liquid electrolyte within the cell, is preparing gel electrodes. These electrodes can be formed from a composition prepared by mixing the necessary components such as electrochemically active material, polymer, and a liquid electrolyte, and subsequently subjecting the composition to a thermal treatment. Such gel electrodes are described in WO 2017/017023 A1, which attempts to manufacture electrochemical devices free of liquid electrolytes.

Gel electrodes are assembled together with other gel or solid-state components to form a cell, thereby reducing the risk of fire due to the removal of free liquid from the cell. The cell manufacturing costs are also reduced because the gel components can be produced by simpler processing steps without the need for slow drying of solvent needed for solvent cast electrodes.

There is a need for processes of manufacturing Li-metal cells which provide the cell with protection from dendrite growth and limit the consumption of electrolyte components, without detrimentally impacting the properties of the Li metal anode. It would also be desirable for such processes to permit the Li metal cell to also incorporate gelled components. Presently, due to the reactivity of the Li metal anode, it is necessary to use only full solid-state (ceramic) cathodes and other solvent-cast or gelled cathodes are excluded. Full solid-state cathodes and complex and expensive to manufacture. Opening up the possibility of using a solvent-cast or gelled cathode alongside a Li metal anode would provide much more flexibility in manufacture and component choice.

The present invention was developed with this in mind, and provides a manufacturing method which enables a Li-metal anode to be protected from dendrite growth while avoiding the detrimental generation of large amounts of Li₃N and Li₂O, and allowing for assembly of the anode with gelled cell components.

### SUMMARY OF THE INVENTION

The invention relates generally to methods of manufacturing an electrode-electrolyte laminate, and in particular to the sequential deposition of layers onto a polymer separator.

A first aspect of the invention is a method of manufacturing an electrode-electrolyte laminate for use in a lithium-metal cell, comprising:
depositing a ceramic electrolyte layer onto a first surface of a polymer separator; and
depositing a layer of lithium metal onto an exposed surface of the ceramic electrolyte layer.

The sequential deposition onto a polymer separator of ceramic electrolyte layer followed by lithium metal offers a number of advantages. Firstly, since the ceramic electrolyte layer is deposited directly onto the polymer separator rather than onto a lithium metal anode layer, the formation of problematic species such as Li₃N and Li₂O is avoided. The inventors found that when the ceramic electrolyte layer is deposited directly onto the Li metal anode, large amounts of Li₃N and Li₂O are formed, in some cases consuming the entire Li metal anode and rendering the cell unusable. By instead depositing the ceramic electrolyte layer directly onto the polymer separator, followed by the deposition of lithium metal onto the ceramic electrolyte layer, a small layer of Li₃N and Li₂O (solid electrolyte interphase) is formed spontaneously between the lithium metal layer and the ceramic electrolyte layer (typically 50-100 nm thick), which does not impair cell function and is in fact beneficial, providing an SEI layer which protects the Li metal anode from consumption or degradation during cell cycling. The so-formed SEI is stable, offering protection which lasts multiple cell cycles.

Secondly, the electrode-electrolyte laminate structure resulting from the method is easily assembled with a cathode layer (either before or after the deposition of the ceramic electrolyte layer), which may be either a traditional solvent-cast cathode or a gelled cathode, providing versatility. Furthermore, it is straightforward to subject the polymer separator itself to a gelling procedure, thereby permitting the manufacture of a cell containing a gel separator. It is therefore possible to use the electrode-electrolyte laminate to manufacture a cell containing a gel separator and gel cathode along with a lithium metal anode, providing all the benefits associated with gel components within a Li-metal cell.

Thirdly, the method is straightforward and efficient since the same equipment and procedure may be used to deposit both the initial ceramic electrolyte layer and the subsequent lithium metal layer, reducing the cost, complexity and environmental impact of manufacture.

A second aspect of the invention provides an electrode-electrolyte laminate for use in a lithium-metal cell, prepared by a method according to the first aspect, comprising:
a polymer separator having a first surface and a second surface;
a ceramic electrolyte layer on the first surface of the polymer separator; and
a lithium metal layer on the surface of the ceramic electrolyte layer.

A third aspect of the invention provides an electrochemical cell comprising the electrode-electrolyte laminate structure according to the second aspect.

A fourth aspect of the invention provides an electrochemical energy storage device comprising the electrochemical cell according to the third aspect.

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

### Ceramic Electrolyte Layer

In some embodiments, the ceramic electrolyte layer comprises a thin film of ceramic electrolyte material in contact with, or adhered to, the first surface of the polymer separator. There may be direct contact between the ceramic electrolyte layer and the first surface of the polymer separator, i.e. no further material layer between the ceramic electrolyte layer and the first surface of the polymer separator.

In some embodiments the ceramic electrolyte layer comprises one or more of lithium phosphorus oxynitride (LiPON), lithium borosilicate (LBSO), lithium phosphate (Li₃PO₄), boron-doped lithium phosphorous oxynitride (LiBPON), lithium silicate, lithium borate, LAGP, LATP, LiSICON, lithium garnet ceramics (e.g. LLTO, LLZO, and LLZTO), and perovskites.

The ceramic electrolyte layer may comprise or consist of a solid inorganic material which conducts lithium ions. The ceramic electrolyte layer may comprise or consist of a solid ceramic material which conducts lithium ions.

In some embodiments the ceramic electrolyte layer comprises a ceramic electrolyte material which has a modulus of at least 5 GPa, for example at least 6 GPa, at least 8 GPa, or at least 10 GPa. Providing a material with this modulus ensures that dendrite growth is mitigated.

In some embodiments the ceramic electrolyte layer comprises or consists of LiPON. LiPON is a known solid Li-ion conductor of general formula LiₓPO_{y}N_{z}. LiPON can be deposited onto the polymer separator at very small thicknesses, for example down to around 100 nm, enabling the dimensions of the cell to be limited. Even at such thicknesses, LiPON retains its ability to prevent or reduce dendrite growth across the cell due to its amorphous and non-porous structure, meaning that there are no grain boundaries or pores through which a dendrite could grow.

In some embodiments, the ceramic electrolyte layer has an amorphous structure. An amorphous ceramic electrolyte layer lacks any grain boundaries which would be present in a crystalline layer. Since grain boundaries could in theory provide a path through which dendrites could grow, an amorphous ceramic electrolyte layer is less prone to the dendrite growth which could lead to cell failure.

In some embodiments, the ceramic electrolyte layer lacks or substantially lacks apertures extending through the plane of the layer. Such apertures are generally known as “pinholes” and may provide another way for dendrites to grow through the electrolyte layer. By ensuring the absence or substantial absence of pinholes, dendrite growth through the layer is further limited. The risk of pinhole formation can be reduced, for example, by ensuring little or no contamination of the polymer separator layer before deposition of the ceramic electrolyte (for example, ensuring no dust formation on the polymer separator layer), and by providing ceramic electrolyte deposition conditions which ensure maximum adatom diffusion over the substrate surface, such that the deposited ceramic electrolyte fills the maximum number of voids on the growing film on the substrate.

In some embodiments the ceramic electrolyte layer is deposited onto the first surface of the polymer separator by a deposition process which involves the gradual deposition of atoms or molecules of the ceramic electrolyte onto the first surface of the polymer separator. In this way, a continuous thin layer may be formed with full contact between the polymer separator and the ceramic electrolyte layer which would not be achievable through the mechanical placement of a pre-formed ceramic electrolyte layer onto the polymer separator. This ensures minimal internal resistance of the cell.

In some embodiments the ceramic electrolyte layer is deposited onto the first surface of the polymer separator by a vacuum deposition processes, preferably by PVD. This ensures controllable thickness of the film and reduced film contamination by conducting deposition under vacuum.

The ceramic electrolyte layer may be deposited onto the first surface of the polymer separator by a PVD process selected from (a) reactive sputtering, or (b) plasma-assisted reactive evaporation.

Reactive sputtering involves RF sputtering of a suitable target using a nitrogen plasma. The target may comprise a material which, when sputtered and then deposited onto the polymer separator, forms the ceramic material of the ceramic electrolyte layer. In embodiments where the ceramic electrolyte layer comprises or consists of LiPON, the target may comprise or consist of lithium phosphate.

Plasma-assisted reactive evaporation involves evaporating a source material in the presence of a nitrogen plasma. The evaporation may be achieved thermally or using an electron gun. The source material may comprise a material which, when sputtered and then deposited onto the polymer separator, forms the ceramic material of the ceramic electrolyte layer. In embodiments where the ceramic electrolyte layer comprises or consists of LiPON, the source material may comprise or consist of lithium phosphate.

Alternatively, deposition of the ceramic electrolyte layer may be achieved by atomic layer deposition (ALD) or chemical vapour deposition (CVD).

In some embodiments, after deposition the ceramic electrolyte layer has a thickness of from about 0.1 μm to about 4 μm, for example from about 0.1 μm to about 3.5 μm, from about 0.1 μm to about 3 μm, from about 0.1 μm to about 2.5 μm, or from about 0.1 μm to about 2 μm.

The thickness of the ceramic electrolyte layer may be controlled by controlling the length of time for which deposition is continued during the vacuum deposition process.

In some embodiments, the ceramic electrolyte layer comprises or consists of LiPON and is deposited onto the first surface of the polymer separator by a PVD method comprising:
preparing a vacuum chamber with a lithium phosphate target and a sputter source;
providing a polymer separator substrate within the vacuum chamber;
providing a vacuum within the vacuum chamber with a pressure of less than 0.1 Pa; and
depositing LiPON onto a first surface of the polymer separator substrate by sputtering the lithium phosphate target.

The sputter source may comprise an RF magnetron.

The polymer separator substrate may be tensioned on a frame within the vacuum chamber to ensure a smooth tensioned surface for even deposition.

Ensuring a vacuum of less than 0.1 Pa minimises the presence of contaminants within the chamber, thereby improving the purity of the deposited LiPON layer. In preferred embodiments, a vacuum of less than 1×10⁻⁴ Pa is provided, further reducing contaminants within the chamber and improving deposited layer purity.

In some embodiments, the step of depositing LiPON onto the surface of the polymer separator substrate by sputtering the lithium phosphate target comprises the following steps:
feeding a continuous supply of nitrogen gas into the vacuum chamber;
applying an RF power supply to RF bias the lithium phosphate target;
forming a nitrogen plasma with the RF field;
sputtering the lithium phosphate target by bombardment with the nitrogen plasma to eject material from the lithium phosphate target into the vacuum chamber; and
condensing material onto the surface of the polymer separator substrate to form the LiPON layer.

In some embodiments, the continuous feed of nitrogen gas is such that the pressure in the vacuum chamber rises to a pressure within the range 0.1 to 1.0 Pa.

### Lithium Metal Layer

The layer of lithium metal is deposited onto an exposed surface of the ceramic electrolyte layer. In other words, after deposition of both the ceramic electrolyte layer and the lithium metal layer, the electrode-electrolyte laminate comprises, in sequence, the polymer separator layer, the ceramic electrolyte layer and the lithium metal layer. The ceramic electrolyte layer is therefore sandwiched between the polymer separator layer and the lithium metal layer.

In some embodiments, after deposition of the lithium metal layer there is no material layer between the ceramic electrolyte layer and the lithium metal layer.

The lithium metal layer comprises or consists of metallic lithium.

In some embodiments, the ceramic electrolyte layer and the lithium metal layer are deposited by the deposition techniques which involve the gradual deposition of atoms or molecules of material onto the surface of a substrate, under vacuum conditions. This simplifies the process, allowing similar methods and equipment to be used for the two deposition steps, reducing the overall manufacturing cost and eliminating the need to remove the polymer separator substrate from a vacuum chamber between deposition steps. In some embodiments, the ceramic electrolyte layer and the lithium metal layer are each deposited by a PVD-type technique. For example, the ceramic electrolyte layer may be deposited by sputtering and the lithium metal layer may be deposited by thermal evaporation, both of which are examples of PVD methods.

In some embodiments, after the deposition of the ceramic electrolyte layer, the substrate may be moved (for example, rotated or translated) within the vacuum chamber to facilitate the subsequent deposition of the lithium metal layer.

In some embodiments, a pre-formed thin film of lithium metal is deposited onto the ceramic electrolyte layer. However such methods are less preferred, because the resultant contact between the ceramic electrolyte layer and the lithium metal layer would be incomplete, leading to variations in current density across the cell which could eventually lead to cell failure. Such methods may also lead to a higher risk of introducing contaminants due to the need to manually manipulate the lithium metal layer. This could also damage the ceramic electrolyte and lithium metal layers.

In some embodiments, the layer of lithium metal is deposited onto the exposed surface of the ceramic electrolyte layer by a deposition process which involves the gradual deposition of lithium atoms onto the ceramic electrolyte layer. In this way, a continuous thin layer may be formed with full contact between the ceramic electrolyte layer and the lithium metal layer, which would not be achievable through the mechanical placement of a pre-formed lithium metal layer onto the ceramic electrolyte layer. This ensures minimal internal resistance of the cell.

In some embodiments the layer of lithium metal is deposited onto the exposed surface of the ceramic electrolyte layer by a vacuum deposition processes, preferably by PVD. This ensures controllable thickness of the film and reduced film contamination by conducting deposition under vacuum.

In some embodiments the ceramic electrolyte layer and the lithium metal layer are sequentially deposited by PVD. In some embodiments the ceramic electrolyte layer and the lithium metal layer are sequentially deposited by PVD without removing the substrate from the vacuum chamber and without venting the vacuum chamber between the deposition steps.

In some embodiments, after deposition the lithium metal layer has a thickness of from about 0.1 μm to about 15 μm, for example from about 0.1 μm to about 12 μm, from about 0.1 μm to about 10 μm, from about 0.1 μm to about 5 μm, or from about 0.1 μm to about 2 μm.

The thickness of the lithium metal layer may be controlled by controlling the length of time for which deposition is continued during the vacuum deposition process.

In some embodiments, vacuum conditions are maintained between the deposition of the ceramic electrolyte layer and the deposition of the lithium metal. This provides a simple and efficient process, removing the need to vent the vacuum chamber or re-establish a vacuum for Li metal deposition.

In some embodiments the lithium metal layer is deposited by thermal evaporation.

In some embodiments, the method comprises providing a thermal evaporation source comprising lithium metal. The thermal evaporation source may comprise a resistively heatable crucible containing lithium metal which is heated to vaporise the lithium.

In some embodiments, the method comprises heating lithium metal under vacuum to a temperature of greater than 250° C. to form Li vapour, for example greater than 300° C., greater than 350° C. or greater than 400° C., and depositing Li onto the exposed surface of the ceramic electrolyte layer from the vapour by condensation. Higher temperatures over 300° C. are preferred, because below this the vapour pressure of lithium may be too low for efficient vaporisation and deposition.

At temperatures of greater than 250° C., for example greater than 300° C., greater than 350° C. or greater than 400° C., when under a vacuum of around 1×10⁻⁶ mbar, molten lithium begins to vaporise and the resultant Li vapour will then condense onto the surface of the ceramic electrolyte layer which has previously been deposited onto the polymer separator substrate, to form a Li metal layer on the ceramic electrolyte layer.

In some embodiments, the Li metal is heated using resistive heating. The heating may be performed in a suitable crucible.

In some embodiments, the lithium metal layer is deposited onto the exposed surface of the ceramic electrolyte layer by a PVD method comprising:
preparing a vacuum chamber with a thermal evaporation source comprising lithium metal;
providing a substrate comprising a layer of ceramic electrolyte deposited onto a polymer separator substrate within the vacuum chamber;
providing a vacuum within the vacuum chamber with a pressure of less than 1×10⁻⁶ mbar; and
depositing lithium metal onto the surface of the ceramic electrolyte layer by vaporising lithium from the thermal evaporation source and condensing lithium onto the ceramic electrolyte layer.

Ensuring a vacuum of less than 1×10⁻⁶ mbar minimises the presence of contaminants within the chamber, thereby improving the purity of the deposited Li layer.

In some embodiments, the method of manufacturing the electrode-electrolyte laminate comprises:
depositing a LiPON layer onto a first surface of a polymer separator; and
depositing a layer of lithium metal onto an exposed surface of the LiPON layer.

In some embodiments, the method of manufacturing the electrode-electrolyte laminate comprises:
depositing a LiPON layer onto a first surface of a polymer separator comprising or consisting of PvDF; and
depositing a layer of lithium metal onto an exposed surface of the LiPON layer; wherein both the deposition of the LiPON layer and the deposition of the layer of lithium metal are achieved by PVD.

In some embodiments, the method of manufacturing the electrode-electrolyte laminate comprises:
preparing a vacuum chamber containing a lithium phosphate target, a sputter source and a thermal evaporation source comprising lithium;
providing a polymer separator substrate within the vacuum chamber;
providing a vacuum within the vacuum chamber with a pressure of less than 1×10⁻⁶ mbar;
depositing LiPON onto the surface of the polymer separator substrate by sputtering the lithium phosphate target, to form a LiPON layer on the surface of the polymer separator substrate;
stopping the deposition of LiPON after a desired thickness of LiPON layer has been achieved;
maintaining vacuum conditions within the vacuum chamber;
depositing lithium metal onto the surface of the LiPON layer by vaporising lithium from the thermal evaporation source and condensing lithium onto the LiPON layer; and
stopping the deposition of lithium metal after a desired thickness of lithium metal layer has been achieved.

### Polymer Separator

The polymer separator has a first surface. During the method of the first aspect, the ceramic electrolyte layer is deposited onto the first surface of the polymer separator. The polymer separator may comprise a second surface, on the other side of the separator from the first surface, which in some embodiments is uncoated before and during the deposition of the ceramic electrolyte layer onto the first surface. In other words, in some embodiments during the step of depositing the ceramic electrolyte layer onto the first surface of the polymer separator, the polymer separator may consist of a single monolithic polymer layer (i.e. the method starts with a “freestanding” polymer separator layer).

In other embodiments, the polymer separator is a polymer layer laminated with a cathode layer. In some embodiments of the method of the first aspect, the polymer separator is laminated to a cathode layer before the step of depositing the ceramic electrolyte layer onto the first surface of the polymer separator (i.e. the method starts with a “supported” polymer separator layer).

Thus in some embodiments the method comprises:
providing a polymer separator laminated with a cathode layer;
depositing a ceramic electrolyte layer onto a first surface of the polymer separator; and
depositing a layer of lithium metal onto an exposed surface of the ceramic electrolyte layer.

In some embodiments the method comprises:
laminating a polymer separator with a cathode layer;
depositing a ceramic electrolyte layer onto a first surface of the polymer separator; and
depositing a layer of lithium metal onto an exposed surface of the ceramic electrolyte layer.

Providing a polymer layer laminated with a cathode layer provides the advantage of a more sturdy and robust substrate for ceramic electrolyte deposition, due to the increased thickness of the substrate relative to a standalone polymer layer.

Furthermore, depositing the polymer separator onto the cathode layer has the effect of “planarising” the cathode surface, allowing the subsequent deposition of a single coherent layer of ceramic electrolyte, which would not be possible if ceramic electrolyte were deposited directly onto the rough surface of a solent-cast cathode layer.

Laminating the polymer separator with the cathode layer may comprise taking a pre-prepared polymer separator comprising a first surface and a second surface, and bringing the second surface into contact with a pre-prepared cathode layer (e.g. solvent cast cathode layer on a current collector) to laminate them together. Alternatively, laminating the polymer separator with the cathode layer may comprise taking a pre-prepared cathode layer and depositing a polymer onto the cathode layer to form a laminate comprising a polymer separator laminated with the cathode layer. For example, polymer may be deposited onto the cathode layer by a method comprising one or more of spin coating and tape casting.

In some embodiments the cathode layer with which the polymer separator is laminated before deposition of the ceramic electrolyte layer is a solvent-cast, porous cathode layer. The cathode layer may be a solvent cast, porous cathode layer deposited upon a support layer, for example a current collector layer. The current collector layer may comprise a metal foil, for example aluminium foil.

Thus in some embodiments, the method comprises:
providing a solvent-cast cathode layer on a current collector layer;
laminating a polymer separator with the cathode layer;
depositing a ceramic electrolyte layer onto a first surface of the polymer separator; and
depositing a layer of lithium metal onto an exposed surface of the ceramic electrolyte layer.

The cathode layer may have a thickness of from about 20 μm to about 100 μm, for example from about 50 μm to about 100 μm, for example from about 50 μm to about 70 μm.

In some embodiments, the polymer separator comprises one or more gelling polymers.

The polymer separator may comprise one or more gelling polymers independently selected from poly(ethyleneglycol dimethacrylate), poly(ethyleneglycol diacrylate), poly(propyleneglycol dimethacrylate), poly(propyleneglycol diacrylate), poly(methyl methacrylate) (PMMA), poly(acrylonitrile) (PAN), polyurethane (PU), poly(vinylidene difluoride) (PVdF), poly(vinylidene fluoride-co-hexafluoropropylene) (PvDF-HFP), poly(ethylene oxide) (PEO), poly-L-lactic acid (PLA), polystyrene (PS), poly(ethyleneglycol dimethylether), poly(ethyleneglycol diethylether), poly[bis(methoxy ethoxyethoxide)-phosphazene], poly(dimethylsiloxane) (PDMS), polyacene, polydisulfide, polystyrene, polystyrene sulfonate, polypyrrole, polyaniline, polythiophene, polythione, polyvinyl pyridine (PVP), polyvinyl chloride (PVC), polyaniline, poly(3,4-ethylenedioxythiophene) (PEDOT), poly(p-phenylene), poly(triphenylene), polyazulene, polyfluorene, polynaphthalene, polyanthracene, polyfuran, polycarbazole, tetrathiafulvalene-substituted polystyrene, ferrocene-substituted polyethylene, carbazole-substituted polyethylene, polyoxyphenazine, poly(heteroacene), poly[(4-styrenesulfonyl) (trifluoromethanesulfonyl)imide-co-methoxy-polyethyleneglycolacrylate] (Li[PSTFSI-co-MPEGA]), sulfonated poly(phenylene oxide) (PPO), N,N-dimethylacryl amide (DMAAm), lithium 2-acrylamido-2-methyl-1-propane sulfonate (LiAMPS), Poly(lithium 2-Acrylamido-2-Methylpropanesulfonic Acid-Co-Vinyl Triethoxysilane), polyethyleneoxide (PEO)/poly(lithium sorbate), PEO/poly(lithium muconate), PEO/[poly(lithium sorbate)+BF₃], PEO copolymer, PEO terpolymer, and NIPPON SHOKUBAI® polymer.

The polymer separator may comprise one or more gelling polymers independently selected from poly(vinylidene difluoride) (PVdF), poly(vinylidene fluoride-co-hexafluoropropylene) (PvDF-HFP), poly(methyl methacrylate) (PMMA), poly(ethylene oxide) (PEO), poly-L-lactic acid (PLA) and polystyrene (PS). In some embodiments, the polymer separator comprises or consists of a single gelling polymer selected from poly(vinylidene difluoride) (PVdF), poly(vinylidene fluoride-co-hexafluoropropylene) (PvDF-HFP), poly(methyl methacrylate) (PMMA), poly(ethylene oxide) (PEO), poly-L-lactic acid (PLA) and polystyrene (PS). In some embodiments, the polymer separator comprises or consists of poly(vinylidene difluoride) (PVdF) or poly(vinylidene fluoride-co-hexafluoropropylene) (PvDF-HFP).

In some embodiments, the polymer separator lacks or substantially lacks apertures extending through the plane of the polymer separator layer. Such apertures are generally known as “pinholes” and may provide a way for dendrites to grow through the polymer separator layer. In addition, if such pinholes are present in the polymer separator, then corresponding pinholes are likely to also be present in the deposited ceramic electrolyte layer. By ensuring the absence or substantial absence of pinholes, dendrite growth through the separator is limited. The risk of pinhole formation can be reduced, for example, by ensuring the formation of a dense polymer material during preparation of the polymer separator, e.g. by extrusion of the polymer into a film or by tape-casting a slurry of polymer powder to form the separator. The choice of polymer can also help reduce the risk of pinhole formation. The inventors have found that PvDF-HFP is a particularly suitable polymer for forming defect-free separators with little or no pinhole formation.

In some embodiments, the polymer separator has a porosity of less than 2%, for example less than 1%, less than 0.5%, less than 0.1% or less than 0.01%. In some embodiments, the polymer separator is 100% dense, i.e. 0% porous. The presence of porosity is undesirable, since it leads to difficulties in forming a conformal film of ceramic electrolyte on the polymer separator.

In some embodiments, the polymer has the ability to support its own weight, i.e. the polymer separator is freestanding. This allows it to be tensioned within the vacuum chamber for deposition of the ceramic electrolyte layer. This may provide particular benefits when the polymer separator is not supported upon a cathode layer during deposition of the ceramic electrolyte layer.

In some embodiments, the polymer used for the polymer separator has a melting point such that it does not melt under the heat of deposition of the ceramic electrolyte layer. The skilled person is able to choose a suitable polymer and tailor the deposition conditions to ensure that this is the case.

In some embodiments, the polymer separator has a thickness of from about 2 μm to about 50 μm, for example from about 2 μm to about 40 μm, for example from about 2 μm to about 5 μm.

The polymer separator is made of a polymer which, when exposed to a suitable amount of liquid electrolyte, swells to form a gel matrix comprising gelled polymer and absorbed liquid electrolyte.

The polymer separator will be “dry”, i.e. non-gelled during the method of depositing the ceramic electrolyte and lithium metal layers, then later subjected to a gelling procedure after the laminate has been manufactured. This could be achieved by soaking the finished laminate structure in liquid electrolyte.

Thus in some embodiments, the method comprises adding a liquid electrolyte to the polymer separator to gel the polymer separator after the deposition of the lithium metal layer.

The liquid electrolyte could be added to the polymer separator either before, during or after assembly of a cell or battery.

To add the liquid electrolyte before assembly of the cell, the laminate may be first soaked in liquid electrolyte to gel the polymer separator, before laminating with a cathode layer to form a cell and then either stacking or rolling multiple cells together to form a battery.

In embodiments where a cathode layer is already present because the polymer separator was initially laminated with a cathode layer, the liquid electrolyte may be introduced for example by adding liquid electrolyte directly to the polymer separator, for example using a syringe or other suitable liquid delivery device which directs the liquid onto the polymer separator.

To add the liquid electrolyte during assembly of the cell, liquid electrolyte may be injected between the polymer separator and cathode layers as these two layers are brought together during assembly, when a cathode layer is not already present. The polymer separator thereby gels as the cell is formed and multiple cells can then be stacked or rolled together to form a battery.

To add the liquid electrolyte after assembly of the cell, liquid electrolyte may be added to the polymer separator and allowed to diffuse laterally through the polymer separator to gel the polymer separator; before either stacking or rolling multiple cells together to form a battery.

The polymer separator may be manufactured by methods known to the skilled person. In some embodiments, the polymer separator is made by taking commercially available powdered form of the desired polymer, forming a slurry of the powder in a suitable solvent and tape casting the slurry to form the separator. Alternatively, the polymer may be extruded to form the polymer separator.

### Passivating Interphase Layer

In some embodiments, the method further comprises the formation of a passivating interphase layer between the ceramic electrolyte layer and the lithium metal layer.

Such a layer may develop spontaneously depending on the method of deposition of lithium metal onto the ceramic electrolyte layer.

In some embodiments, the passivating interphase layer between the ceramic electrolyte layer and the lithium metal layer comprises or consists of Li₃PO₄, Li₃N and LiO₂.

The passivating layer provides a stable SEI which protects the lithium metal anode layer. It functions to limit the consumption or degradation of lithium from the lithium anode during cycling of the cell.

The amount of Li₃N in the passivating layer is much lower than would arise from the deposition of LiPON onto a lithium metal anode by PVD. This is because PVD of LiPON onto a lithium metal anode requires the feeding of nitrogen gas into the system during deposition, resulting in high levels of Li₃N formed at the lithium anode surface. By contrast, the present method first forms a layer of ceramic electrolyte (e.g. LiPON) on the polymer separator, before depositing lithium metal using thermal evaporation which does not require nitrogen. The passivating layer forms purely from the reaction between the LiPON layer and the lithium metal layer after deposition. The amount of Li₃N at the layer interface is therefore minimised and the performance of the cell is not detrimentally affected.

### Encapsulation Layer

In some embodiments, the method of the invention further comprises the step of providing a protective encapsulation layer on the exposed surface of the layer of lithium metal. In this way, a laminate structure is formed comprising the following layers, in sequence: optional cathode layer, polymer separator, ceramic electrolyte, lithium metal, encapsulation.

The protective encapsulation layer may protect the lithium metal layer from reaction with the air. This helps to maintain the purity of the lithium metal layer between manufacture of the electrode-electrolyte laminate and its incorporation into a cell, thereby improving the performance of the cell.

In some embodiments, the encapsulation layer is deposited onto the exposed surface of the lithium metal layer by a deposition process which involves the gradual deposition of atoms or molecules onto the lithium metal layer.

In some embodiments the encapsulation layer is deposited onto the exposed surface of the lithium metal layer by a vacuum deposition process, preferably by PVD. This ensures controllable thickness of the film and reduced film contamination by conducting deposition under vacuum.

Alternatively, deposition of the encapsulation layer may be achieved by atomic layer deposition (ALD) or chemical vapour deposition (CVD).

In some embodiments the ceramic electrolyte layer, the lithium metal layer and the encapsulation layer are sequentially deposited by PVD. In some embodiments the lithium metal layer and the encapsulation layer are sequentially deposited by PVD without removing the substrate from the vacuum chamber and without venting the vacuum chamber between the deposition steps. In some embodiments the ceramic electrolyte layer, the lithium metal layer and the encapsulation layer are sequentially deposited by PVD without removing the substrate from the vacuum chamber and without venting the vacuum chamber between the deposition steps. This ensures little or no contamination of the laminate as layers are built up, and provides a more efficient and lower-cost process due to minimal equipment use and no need for the reestablishment of a vacuum during manufacture.

In some embodiments, the encapsulation layer completely covers all exposed surfaces of the layer of lithium metal. In other words, the encapsulation layer may cover both the exposed upper (planar) surface of the layer of lithium metal and also all edges of the layer of lithium metal, such that the encapsulation layer makes contact with the ceramic electrolyte layer around the periphery of the lithium metal layer. In this way, no lithium metal remains exposed to the external atmosphere and contamination of the lithium metal is minimised.

The skilled person is aware of materials suitable to be deposited onto the lithium metal layer as an encapsulation layer. The encapsulation layer will have chemical and electrochemical stability with respect to lithium metal, will be impermeable or substantially impermeable to air (to protect the lithium from reaction with air), and in some embodiments is sufficiently thin to not be detrimental to the volumetric and gravimetric energy density of the cell.

In some embodiments, the encapsulation layer is a metallic encapsulation layer. In some embodiments, the encapsulation layer is an electrically conducting metallic encapsulation layer. In this way, the lithium metal layer is encapsulated while preserving the ability to make an electrical connection with the lithium through the electrically conducting metallic encapsulation layer. In some embodiments, the encapsulation layer is a metallic encapsulation layer comprising or consisting of one or more metal elements selected from Cu, W, Mo and any other metal element which is chemically and electrochemically stable with respect to lithium metal. In some embodiments, the encapsulation layer is a metallic encapsulation layer comprising or consisting of one or more metal elements selected from Cu, W and Mo.

In some embodiments, the encapsulation layer is a polymeric encapsulation layer or a ceramic encapsulation layer. However this is less preferred to a metallic encapsulation layer, since the electrical conductivity of a polymer or ceramic is generally lower than a metallic layer, making it more difficult to ensure that an electrical connection can be made with the lithium anode. In some embodiments, the encapsulation layer is an electrically conducting polymeric encapsulation layer or an electrically conducting ceramic encapsulation layer.

In some embodiments, the encapsulation layer is not removed from the lithium metal layer before assembly of the cell, such that the finished cell comprises the encapsulation layer between the lithium metal layer and an anode current collector layer.

### Cathode Layer

As explained above, a cathode layer may be laminated with the polymer separator before deposition of the ceramic electrolyte layer. In this way, after deposition of the ceramic electrolyte layer, lithium metal layer and (optional) encapsulation layer, the electrode-electrolyte laminate already comprises two electrodes separated by the polymer separator.

Alternatively, the ceramic electrolyte layer may be deposited onto a freestanding polymer separator and the electrode-electrolyte laminate is only combined with a cathode layer after the deposition of ceramic electrolyte, lithium metal and encapsulation layers. Thus in some embodiments the method further comprises placing a second surface of the polymer separator into contact with a cathode layer. In other words, one surface of the polymer separator is in contact with the ceramic electrolyte layer and the remaining surface is placed into contact with a cathode layer. After assembly with the cathode layer, the polymer separator is therefore sandwiched between the cathode layer and the ceramic electrolyte layer.

In some embodiments the cathode layer comprises a gel cathode or a solvent-cast cathode.

In some embodiments the second surface of the polymer separator is not coated with any layer of ceramic electrolyte between the polymer separator and the cathode layer.

In some embodiments, the cathode layer comprises liquid electrolyte which combines with the polymer separator to form a gel when the cathode layer is brought into contact with the polymer separator. In other words, the polymer separator is “dry” and gelation occurs due to contact between the “dry” polymer separator layer of the laminate and a “wet” cathode layer. This allows gelation to occur simultaneously with the assembly of the cell without the need for any separate step of adding or injecting liquid electrolyte.

The ceramic electrolyte (e.g. LiPON) layer acts as a barrier between the “dry” lithium metal anode and the “wet” components of the cell, i.e. the gelled polymer separator and the cathode layer. This provides a cell which carries the benefits associated with lithium metal anode (e.g. high energy density) and gelled components (e.g. increased operational safety and high ionic conductivity).

The cathode layer may be a “conventional” solvent-cast cathode. Such a cathode comprises a positive active material and may also comprise one or more of a binder, liquid electrolyte and a conductive additive. Such cathodes are made by preparing a slurry of the above-mentioned components in a solvent and casting the solvent onto a current collector, before drying and optionally calendaring to increase the density of the electrode.

Alternatively the cathode may be a gel cathode. The gel cathode may comprise a polymer-electrolyte gel matrix phase and a dispersed phase comprising a positive active material. The dispersed phase may further comprise a conductive additive. The polymer-electrolyte gel matrix phase comprises a gel comprising a polymer and absorbed liquid electrolyte. The polymer may be selected from one or more of the polymers listed above as options for the polymer separator. In some embodiments, the liquid electrolyte comprises or consists of a solvent comprising one or more cyclic or linear carbonate compounds. In some embodiments the solvent comprises one or more cyclic carbonate compounds. In some embodiments the solvent comprises one or more of ethylene carbonate, propylene carbonate, dimethyl carbonate, diethyl carbonate, ethyl-methyl carbonate, butylene carbonate, vinylene carbonate, fluoroethylene carbonate, fluoropropylene carbonate and γ-butyrolactone. In some embodiments, the liquid electrolyte further comprises a lithium salt. Examples of suitable lithium salts include LiPF₆, LiBF₄ and lithium bis(trifluoromethanesulfonyl)imide (LiTFSI).

### Electrode-Electrolyte Laminate

A second aspect of the invention is an electrode-electrolyte laminate for use in a lithium-metal cell, prepared by a method according to the first aspect, comprising:
a polymer separator having a first surface and a second surface;
a ceramic electrolyte layer on the first surface of the polymer separator; and
a lithium metal layer on the surface of the ceramic electrolyte layer.

In some embodiments, the electrode-electrolyte laminate comprises a cathode layer in contact with the second surface of the polymer separator. In other words, the electrode-electrolyte laminate may comprise the following layers, in sequence: cathode layer, polymer separator, ceramic electrolyte, lithium metal. The cathode layer may in turn be in contact with a cathode current collector layer.

In some embodiments, the electrode-electrolyte laminate comprises an encapsulation layer on the surface of the lithium metal layer. In other words, the electrode-electrolyte laminate may comprise the following layers, in sequence: optional cathode layer, polymer separator, ceramic electrolyte, lithium metal, encapsulation layer.

In some embodiments, the electrode-electrolyte laminate does not comprise a current collector in contact with the lithium metal layer. Other methods of manufacturing laminates which rely on the deposition of lithium metal on a current collector would inevitably lead to a laminate in which lithium metal is in contact with a current collector, for example a copper foil. Since the present method builds the laminate from the polymer separator, the initial laminate does not contain a current collector and is able to be contacted with a current collector later during assembly of a cell.

In some embodiments the electrode-electrolyte laminate comprises a cathode layer in contact with the second surface of the polymer separator. This cathode layer may be laminated with the polymer separator either before or after deposition of the ceramic electrolyte layer.

In some embodiments, the cathode layer comprises a gel cathode or a solvent-cast cathode.

In some embodiments, the second surface of the polymer separator is not coated with any layer of ceramic electrolyte between the polymer separator and the cathode layer.

In some embodiments, the ceramic electrolyte layer comprises or consists of LiPON.

In some embodiments, the ceramic electrolyte layer has an amorphous structure.

In some embodiments, the polymer separator comprises one or more gelling polymers independently selected from poly(vinylidene difluoride) (PVdF), poly(methyl methacrylate) (PMMA), poly(ethylene oxide) (PEO), poly-L-lactic acid (PLA) and polystyrene (PS).

A third aspect of the invention is an electrochemical cell comprising the electrode-electrolyte laminate structure according to the second aspect.

A fourth aspect of the invention is an electrochemical energy storage device comprising the electrochemical cell according to the third aspect.

### BRIEF DESCRIPTION OF THE DRAWINGS

FIG. 1 schematically illustrates a method of manufacturing an electrode-electrolyte laminate product.

FIG. 2 is an SEM of an intermediate laminate product in cross section, including a PvDF polymer separator layer and a LiPON ceramic electrolyte layer.

FIG. 3 is an SEM of an electrode-electrolyte laminate product in cross section, including a PvDF polymer separator layer, a LiPON ceramic electrolyte layer and a lithium metal anode layer.

FIG. 4 schematically illustrates an electrode-electrolyte laminate built from the anode current collector in accordance with a prior art method.

FIG. 5 schematically illustrates an electrode-electrolyte laminate built from the polymer separator, according to the method of the invention.

FIG. 6 schematically illustrates a method of manufacturing an electrode-electrolyte laminate product.

FIGS. 7a and 7b are SEM images of an electrode-electrolyte laminate product in cross section, including a PvDF polymer separator layer on a cathode layer, and a LiPON ceramic electrolyte layer.

FIG. 8 is a schematic representation of the structure of a half-cell containing the laminate of the invention during testing.

FIG. 9 is an electrochemical plot showing charge-discharge curves for 5 cycles of a half-cell.

FIG. 10 schematically illustrates a coin cell in cross-section partially disassembled.

FIG. 11 shows the charge-discharge curves for 26 cycles of a full cell at C/100.

### EXAMPLES

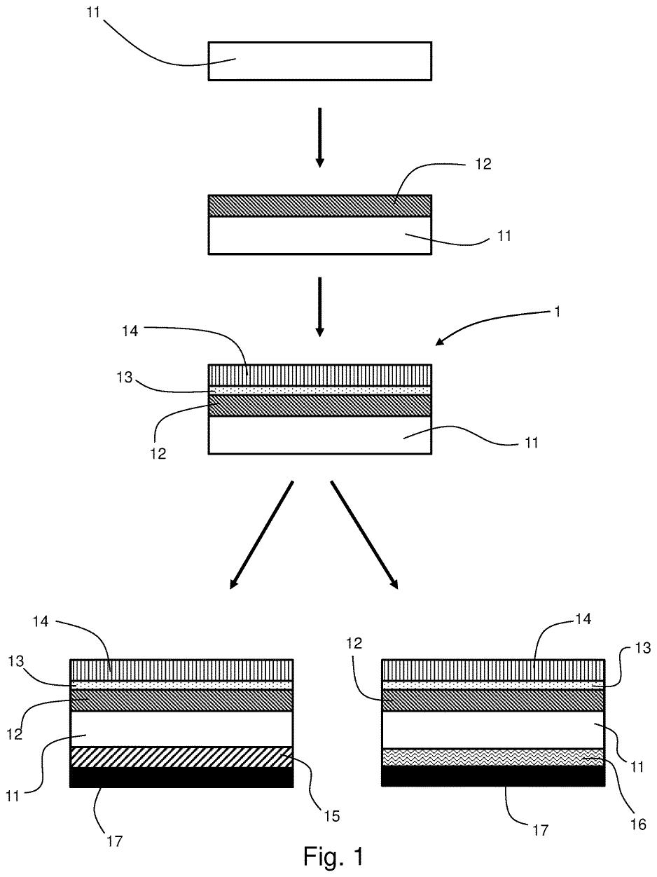

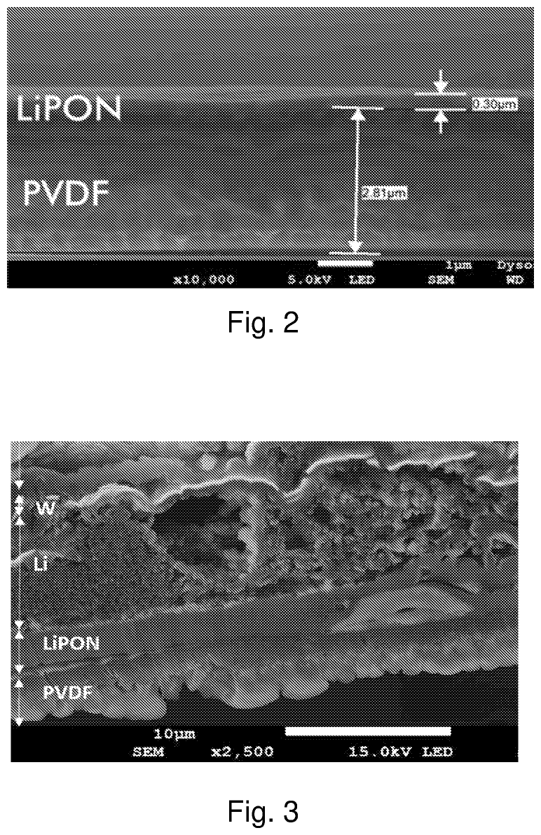

FIG. 1 is a schematic illustration of a method of manufacturing an electrode-electrolyte laminate 1 according to the invention, along with further downstream processing steps.

The sequential deposition of LiPON, lithium metal (anode layer) and tungsten metal (encapsulation layer) is done in the same small-scale modular deposition system with a vacuum chamber attached to argon and nitrogen gas bottles.

The vacuum chamber (not shown) is first prepared including two separate deposition sources: an RF magnetron sputter source with a lithium phosphate target (5.08 cm diameter); and a thermal evaporation source made up of a resistively heatable crucible containing Li metal.

A PvDF polymer separator 11 is tensioned on a frame and loaded into the vacuum chamber, positioned directly above the deposition sources. The vacuum chamber is pumped down to 1×10⁻⁴ Pa.

A layer of LiPON 12 is then deposited by the following method. Firstly, a continuous supply of N₂/Ar gas mixture (Ar flow 16 sccm; N₂ flow 30 sccm) is fed into the vacuum chamber, bringing the chamber pressure to 0.15 Pa. An RF power supply (145 W) is then used to RF bias the lithium phosphate target in the RF magnetron sputter source. The polymer substrate is 9.5 cm from the sputter gun. The polymer substrate is rotated at 20 RPM during LiPON deposition. Resultant sputtering of material from the target causes condensation of the LiPON layer 12. A 500 nm thick layer of LiPON is deposited over a 10 hour period. The RF power supply and supply of gas are then turned off, but the vacuum within the vacuum chamber is maintained.

A layer of lithium metal 13 is then deposited by the following method. The crucible containing lithium metal is resistively heated to around 400° C. at 1×10⁻⁴ Pa pressure to first melt and then vaporise Li. The lithium source is positioned 21 cm away from the substrate. The substrate is rotated at 20 RPM during Li deposition. The Li vapour condenses onto the LiPON layer 12 to form the Li layer 13. A 10 μm thick layer of lithium is deposited over a 2 hour period.

A tungsten encapsulation layer 14 is then deposited onto the surface of the lithium metal layer 13 to protect the lithium metal from reaction with air, which would occur once the vacuum chamber is vented. In the same vacuum chamber which was used for LiPON and Li deposition, and without breaking vacuum between the depositions, Wis deposited directly onto the lithium metal layer using RF magnetron sputtering (200 W RF power). A 60 sccm flow of argon gas is used (0.2 Pa working pressure) is used and the lithium metal substrate is positioned 13.5 cm from the sputter gun. The substrate is rotated at 20 RPM during W deposition. Sputtering is continued until a 100 nm thick film of tungsten is formed on the substrate.

After deposition of the encapsulation layer, the vacuum chamber is vented to atmospheric pressure and the laminate is removed from the chamber.

The resultant laminate 1 can then be combined with different types of cathode layer. In one embodiment, a solvent-cast cathode layer 15 is cast onto a current collector layer 17 by preparing a slurry of cathode active material and optional additives in a solvent, casting the slurry onto a current collector substrate and allowing the solvent to evaporate. After an optional calendaring step, the laminate of cathode layer 15 on current collector 17 is brought into contact with the polymer separator layer 11 of the laminate 1, creating a cell structure.

Alternatively, a gel electrode layer 16 on a current collector layer 17 is brought into contact with the polymer separator layer 11 of the laminate 1, by contacting the gel electrode layer 16 with the polymer separator layer 11, creating a cell structure. The gel electrode layer contains a gelling polymer, which may be gelled by the introduction of a liquid either before, after or during the process of contacting the gel electrode layer 16 with the polymer separator layer 11. The liquid which is used to gel the cathode layer 16 will also cause the gelation of the polymer separator layer 11. One example of a suitable liquid is an electrolyte comprising dimethyl carbonate (DMC) and one or more lithium salts.

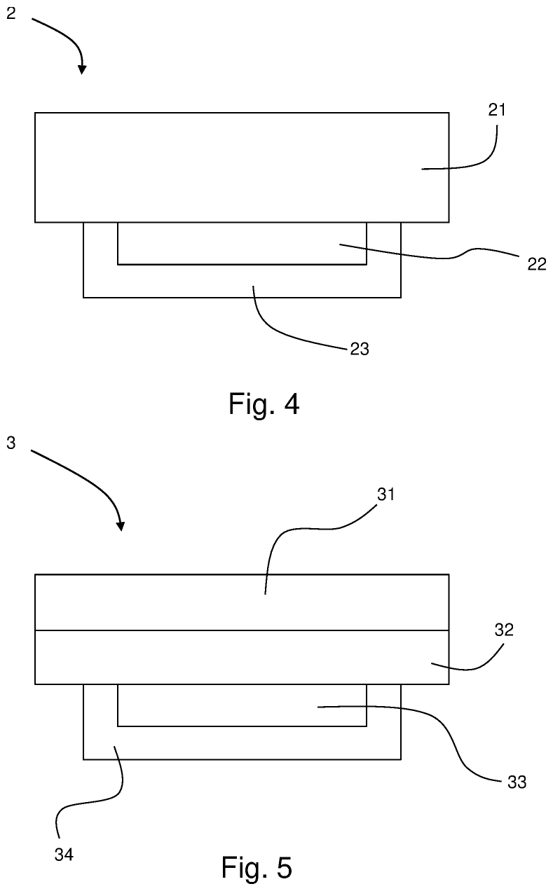

FIG. 4 shows a schematic representation of a laminate formed by a method of the prior art in which a LiPON layer is deposited onto a lithium metal anode. An anode current collector layer 21 carries a lithium metal anode layer 22. After the deposition of LiPON onto the lithium metal, a LiPON layer 23 is formed which encapsulates the lithium metal layer. It is expected that high levels of contaminants such as Li₃N and Li₂O at the interface between the lithium metal and the LiPON.

FIG. 5 shows a schematic representation of a laminate formed by a method of the invention in which a LiPON layer is deposited onto a polymer separator. A polymer separator layer 31 carries a layer of LiPON 32. A layer of lithium metal is then deposited onto the LiPON to form a lithium metal anode layer 33. Finally, an encapsulation layer 34 is formed which fully encapsulates the lithium metal layer 33, thereby protecting it from reaction with the air.

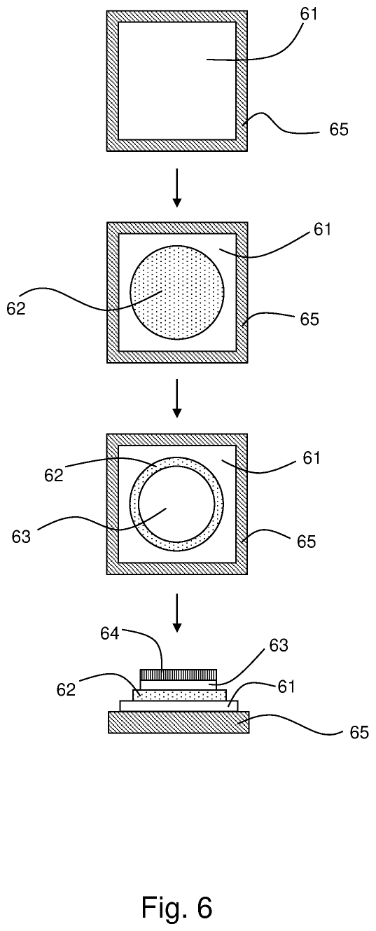

FIG. 6 shows a schematic representation of a method of forming a laminate by depositing a LiPON layer onto a polymer separator which is laminated with a cathode layer. A solvent-cast cathode layer 65 carries a polymer separator layer 61 made of PvDF. A layer of LiPON 62 is deposited onto the polymer separator layer by the process described above in relation to FIG. 1. A layer of lithium metal is then deposited onto the LiPON to form a lithium metal anode layer 63. Finally, an encapsulation layer 64 is formed on the lithium metal anode layer 63. Liquid electrolyte (not shown) can then be added by direct addition using a syringe or other suitable liquid delivery device to the PvDF layer. The PvDF layer 61 extends beyond the boundaries of the LiPON layer 62, providing an exposed area of PvDF around the periphery of the LiPON layer to which liquid electrolyte can be easily added.

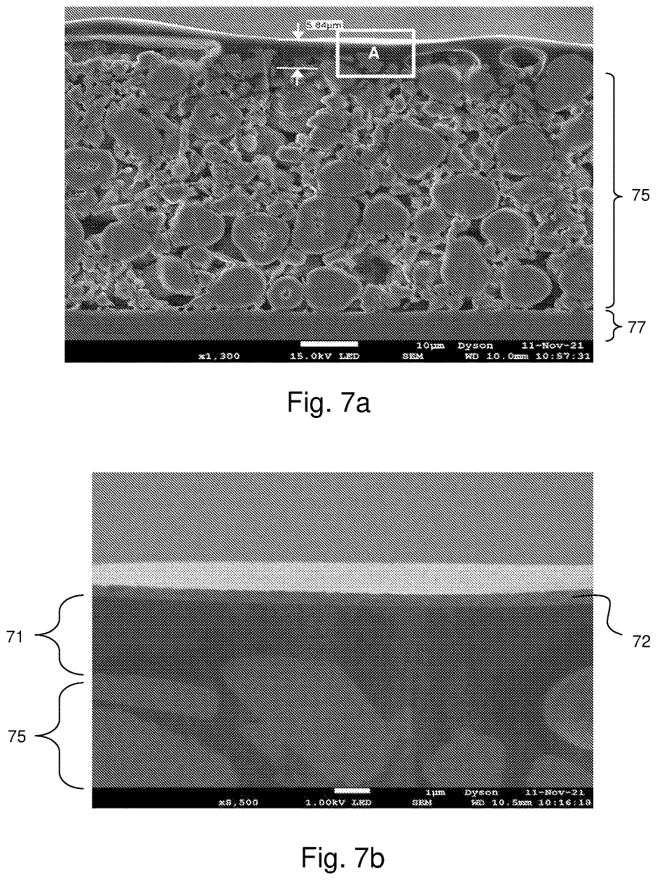

FIGS. 7a and 7b are SEM images of an electrode-electrolyte laminate product in cross section, including a solvent-cast cathode layer, PvDF polymer separator layer and a LiPON ceramic electrolyte layer, manufactured according to the method schematically depicted in FIG. 6 (i.e. starting from a polymer separator supported on a cathode layer). FIG. 7b shows a detailed view of the area of FIG. 7a covered by the white box labelled “A”. The laminate includes a solvent-cast cathode layer 75 of approximate thickness 60 μm on an aluminium foil current collector layer 77. The cathode layer 75 carries a PVdF layer 71 approximately 5-6 μm thick, which in turn carries a LiPON layer 72 approximately 200 nm thick.

### Example 1—Li Ion Shuttling within Half-Cell

A PvDF separator was coated first with LiPON and then with Li according to the method described above to form a PvDF/LiPON/Li stack.

The PvDF separator was 10 μm thick, the LiPON layer was 300 nm thick, the Li metal layer was 8 μm thick and the W encapsulation layer was 100 nm thick.

A 12 mm diameter disc was punched out of the stack for testing.

The disc was fitted into a Swagelok tube and a glass fibre separator soaked in liquid electrolyte was placed against the PvDF layer. Lithium foil was placed against the other side of the glass fibre separator to complete the half-cell. An o-ring was fitted within the Swagelok tube around the glass fibre separator and the lithium foil, to ensure that the only available pathway for Li ion transport was through the LiPON and PvDF layers.

Plungers were put in place within the Swagelok tube on either side of the cell to hold the components together. A Kapton and Cu foil layer provided an interface with the W encapsulation layer on the anode side.

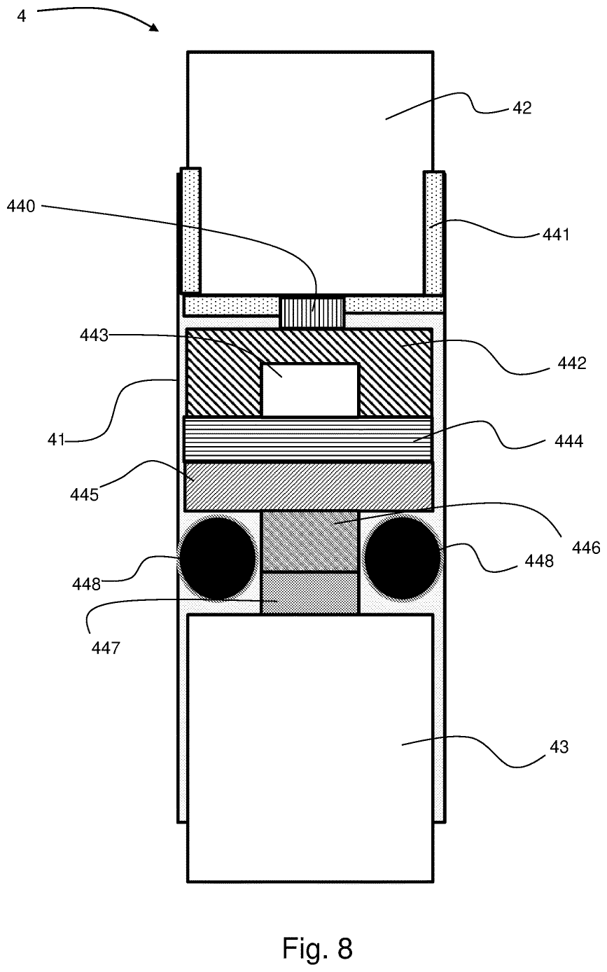

FIG. 8 is a schematic representation of the structure of the half-cell 4 during testing. Swagelok tube 41 contains the entire half-cell. Plungers 42 and 43 are located within the tube 41 at either end of the half-cell. Plunger 42 is covered with a layer of Kapton 441 and interfaces with a Cu foil layer 440. The Cu foil 440 contacts the tungsten encapsulation layer 442 of the half-cell, which in turn encapsulates the Li metal anode layer 443. A layer of LiPON 444 covers the Li metal layer 443. A layer of gelled PvDF 445 contacts the LiPON layer 444. The PvDF layer 445 contacts a liquid electrolyte-soaked glass fibre layer 446 which in turn contacts a Li foil layer 447. A rubber o-ring 448 surrounds the glass fibre layer 446 and Li foil layer 447 between those layers and the inner surface of the tube 41.

The half-cell was cycled against the Li foil at a rate of 0.03 mA/cm² (approximately C/100). The cycling time was fixed to represent a charge/discharge of approximately 10% of capacity. The cell was cycled 5 times.

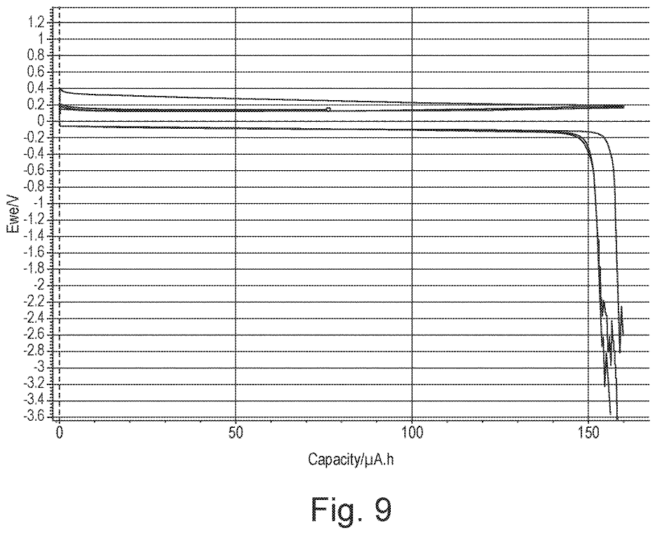

FIG. 9 shows the charge-discharge curves for the 5 cycles of the half-cell.

During a first step of cycling, Li is extracted from beneath the LiPON layer. This first cycle was 0.1 V higher than subsequent cycles, perhaps suggesting that Li plating sites were being established on the Li foil side. The +0.2 V potential for transporting Li from beneath the LiPON across the cell to the Li foil was relatively low, perhaps indicating that full gelation of the PvDF layer had not been achieved. The introduction of further liquid electrolyte to more completely gel the polymer may help reduce the impedence of the half-cell and increase the potential.

During a second step, Li is removed from the Li foil and transported through the PvDF layer then through the LiPON layer to the W-encapsulated Li metal layer. The potential was approximately the same as the extraction from the LiPON side, indicating that Li ions are passing directly through the PvDF and LiPON layers and that there is no alternative Li plating pathway. This shows that Li is being successfully re-plated onto the Li metal layer adjacent the LiPON layer, such that repeated cycling of a cell containing the Li/LiPON/PvDF stack is possible.

### Example 2—Li Ion Shuttling within Full Cell

A polystyrene separator was coated first with LiPON and then with Li according to the method described above (expect that a PS separator substrate was used in place of PvDF, and no encapsulation layer was deposited) to form a PS/LiPON/Li stack.

The PS separator was 29 μm thick, the LiPON layer was 600 nm thick and the Li metal layer was 10 μm thick.

A disc was punched out of the stack and was incorporated into a coin cell for testing alongside an NMC gel cathode, gelled with DMC/LiFSI liquid electrolyte.

FIG. 8 is a schematic representation of the structure of the coin cell 5 during assembly, shown in vertical cross-section.

The coin cell 5 includes a coin cell cap 501 and a coin cell base 502. The coin cell contains the PS/LiPON/Li stack 503 which consists of LiPON layer 505 sandwiched between PS layer 504 and Li metal layer 506. The Li metal layer 506 lies in contact with the coin cell base 502. Coin cell gasket 507 sits on the surface of the PS layer 504 to hold the stack in place within the coin cell and abuts the annular, vertically extending external wall of the coin cell base 502.

Coin cell spring 508 lies in the space between the coin cell cap 501 and a coin cell spacer 509. On the other side of the spacer is an NMC gel cathode 510. During manufacture of the coin cell, liquid electrolyte comprising LiFSI salt in DMC solvent was injected into the gap between the NMC cathode 510 and the PS separator 504 using a syringe, before closure of the coin cell 5. After injection of the electrolyte, the dry NMC cathode layer 510 becomes gelled. The coin cell is then closed by bringing the coin cell cap 501 towards the base 502 until the gelled NMC cathode 510 comes into contact with the PS layer 504, thereby forming the full cell.

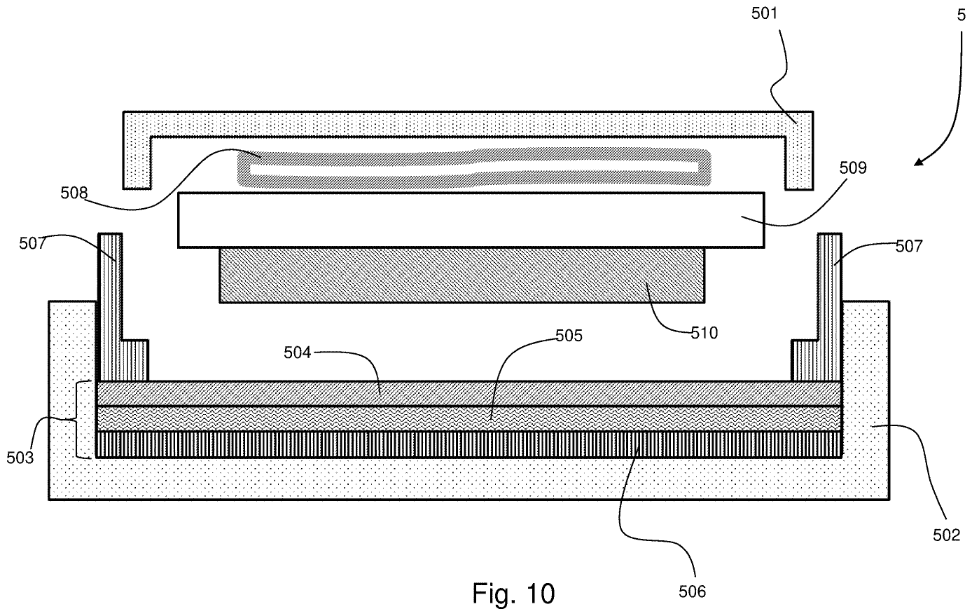

FIG. 10 shows the coin cell partially disassembled, with a space between the PS separator 504 and the NMC cathode 510, into which the liquid electrolyte was injected before closing the coin cell.

The coin cell was cycled at a rate of C/100. The cell was successfully cycled 26 times, showing that the PS/LiPON/Li stack facilitates the transport of Li ions across a full cell.

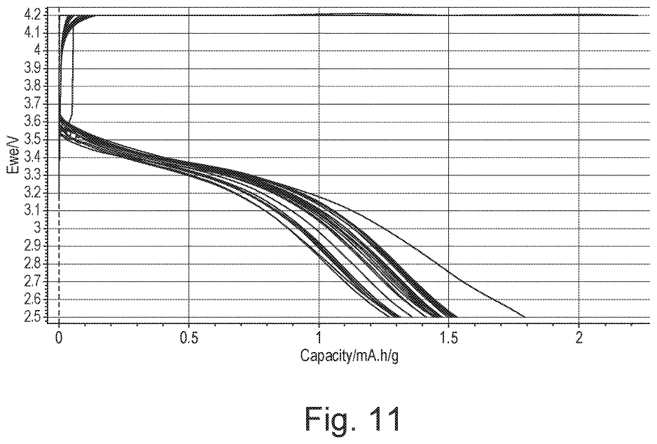

FIG. 11 shows the charge-discharge curves for the 26 cycles of the cell at C/100. Cycling was performed using a CCCV regime (constant current, constant voltage) during charge and a CC regime (constant current) during discharge. The cell charged to 4.2 V under CCCV and discharged to 2.5 V under CC.

The results show that the building of an electrode-electrolyte laminate starting from the polymer separator, with the deposition first of a ceramic electrolyte such as LiPON, and second of a lithium metal layer, can produce a stack which effectively transports lithium ions within a full cell format when coupled with an appropriate cathode layer.

1-25. (canceled)

26. A method of manufacturing an electrode-electrolyte laminate for use in a lithium-metal cell, comprising:
depositing a ceramic electrolyte layer onto a first surface of a polymer separator; and
depositing a layer of lithium metal onto an exposed surface of the ceramic electrolyte layer.

27. The method according to claim 26, wherein the ceramic electrolyte layer comprises or consists of one or more of LiPON, LAGP, LATP, LiSICON, perovskites and garnet ceramics.

28. The method according to claim 26, wherein the ceramic electrolyte layer comprises or consists of LiPON.

29. The method according to claim 26, wherein the ceramic electrolyte layer has an amorphous structure.

30. The method according to claim 26, wherein the ceramic electrolyte layer is deposited onto the first surface of the polymer separator by a deposition process which involves the gradual deposition of atoms or molecules of the ceramic electrolyte onto the first surface of the polymer separator.

31. The method according to claim 26, wherein the layer of lithium metal is deposited onto the exposed surface of the ceramic electrolyte layer by a deposition process which involves the gradual deposition of lithium atoms onto the ceramic electrolyte layer.

32. The method according to claim 26, wherein vacuum conditions are utilized during the deposition of the ceramic electrolyte layer and the deposition of the lithium metal, and vacuum conditions are maintained between the deposition of the ceramic electrolyte layer and the deposition of the lithium metal.

33. The method according to claim 26, wherein the polymer separator comprises one or more gelling polymers.

34. The method according to claim 33, wherein the one or more gelling polymers are independently selected from poly(vinylidene difluoride) (PVdF), poly(methyl methacrylate) (PMMA), poly(ethylene oxide) (PEO), poly-L-lactic acid (PLA) and polystyrene (PS).

35. The method according to claim 26, further comprising adding a liquid electrolyte to the polymer separator.

36. The method according to claim 26, wherein the polymer separator has a thickness of from about 2 μm to about 5 μm.

37. The method according to claim 26, wherein after deposition the ceramic electrolyte layer has a thickness of from about 0.1 μm to about 4 μm.

38. The method according to claim 26, wherein after deposition the layer of lithium metal has a thickness of from about 5 μm to about 15 μm.

39. The method according to claim 26, further comprising placing a second surface of the polymer separator into contact with a cathode layer after deposition of the layer of lithium metal, or further comprising laminating the polymer separator to a cathode layer before the step of depositing the ceramic electrolyte layer onto the first surface of the polymer separator.

40. The method according to claim 39, wherein the cathode layer comprises a gel cathode or a solvent-cast cathode.

41. The method according to claim 39, wherein the second surface of the polymer separator is not coated with any layer of ceramic electrolyte between the polymer separator and the cathode layer.

42. An electrode-electrolyte laminate for use in a lithium-metal cell, prepared by a method according to claim 26, comprising:
a polymer separator having a first surface and a second surface;
a ceramic electrolyte layer on the first surface of the polymer separator; and
a lithium metal layer on the surface of the ceramic electrolyte layer.

43. The electrode-electrolyte laminate structure according to claim 42, comprising a cathode layer in contact with the second surface of the polymer separator.

44. The electrode-electrolyte laminate structure according to claim 43, wherein the second surface of the polymer separator is not coated with any layer of ceramic electrolyte between the polymer separator and the cathode layer.

45. An electrode-electrolyte laminate structure according to claim 42, wherein the ceramic electrolyte layer comprises or consists of LiPON.
